(19) United States
(12) Patent Application Publication
(10) Pub. No.: US 2018/0296916 A1
(43) Pub. Date: Oct. 18, 2018

(54) SYSTEM AND METHOD FOR SPATIAL AND IMMERSIVE COMPUTING

(71) Applicant: Penrose Studios, Inc., San Francisco, CA (US)

(72) Inventors: Eugene CHUNG, San Francisco, CA (US); James MAIDENS, San Francisco, CA (US); Devon PENNEY, Seattle, WA (US); Keeyune CHO, Berkeley, CA (US); Leftheris KALEAS, San Francisco, CA (US)

(73) Assignee: PENROSE STUDIOS, INC.

(21) Appl. No.: 15/953,341

(22) Filed: Apr. 13, 2018

Related U.S. Application Data
(60) Provisional application No. 62/485,675, filed on Apr. 14, 2017.

(51) Int. Cl. A63F 13/352; H04L 29/06; G06T 19/00; G06F 3/0481; G06F 9/448

(52) U.S. Cl. CPC A63F 13/352; H04L 67/38; A63F 2300/8082; G06F 3/04815; G06F 9/4498; G06T 19/006

(57) ABSTRACT

A system for networked immersive computing (IC) experience playback and review that allows reviewers to experience a multi-user, fully synchronized environment. The system provides tools synchronized and distributed playback control, laser pointers, voice communication, virtual avatars, and replicated virtually-drawn brush strokes. The system also creates actionable media, such as networked strokes that can be exported for use in third party content creation tools, allowing for seamless real world follow-through on notes taken in the virtual world or virtual environment.

### CROSS-REFERENCE TO RELATED APPLICATIONS

This application claims priority to U.S. Provisional Patent Application Ser. No. 62/485,675, filed on Apr. 14, 2017, the disclosure of which is expressly incorporated herein by reference in its entirety and for all purposes.

### FIELD

The disclosed embodiments relate generally to immersive video systems and more particularly, but not exclusively, to methods and systems for video generation, review, and playback, for example, in a virtual reality (VR) environment.

### BACKGROUND

Creating experiences for spatial and immersive computing (IC)—including virtual reality (VR), augmented reality (AR), mixed reality (MR), extended reality (XR), and so on—has several challenges that are introduced once an editor leaves the safety of the screen.

When creating content for an IC platform, reviewing the content carries similar challenges with context switching between a traditional environment and a fully positional three dimensional (3D) virtual environment. Conventionally, reviews are carried out with a single reviewer in the immersive experience—for example, in a VR head-mounted display (HMD)—while other reviewers watch the single reviewer's perspective from “outside VR” on a two-dimensional (2D) computer monitor. This can create a large disconnect between what the single reviewer in the headset sees and what the reviewers outside the headset see. This also creates subsequent difficulties in communicating notes in an environment where perspective matters a great deal.

As another technical challenge, “reviews” are collaborative processes that require the input of several different reviewers. In a traditional review process, participants can easily take control of playback by grabbing the keyboard of the playback machine or the TV remote. It is difficult to replicate this environment within an IC system where any participant can take control of playback at any given point in time. Furthermore, this can create conflicts where two people issue the same command at the same time (e.g., “skip forward 5 seconds”), leading to unexpected results and causing confusion in the middle of a review.

In view of the foregoing, a need exists for systems and methods for improved networked IC experience playback and review to overcome the aforementioned obstacles and deficiencies of conventional media review systems.

### BRIEF DESCRIPTION OF THE DRAWINGS

FIG. 1 is an exemplary top-level block diagram illustrating an embodiment of an immersive computing management system.

FIG. 2 is an exemplary top-level block diagram illustrating an embodiment of the IC management platform of FIG. 1.

FIG. 3 is an exemplary top-level block diagram illustrating an embodiment of the data flow for entering a review session of the IC management system of FIG. 1.

FIG. 4 is an exemplary top-level block diagram illustrating an embodiment of the world state diagram of the IC management system of FIG. 1.

FIG. 5 is an exemplary top-level block diagram illustrating an embodiment of the data flow for resolving conflicts between users of the IC management system of FIG. 1.

FIG. 6 is an exemplary top-level block diagram illustrating an embodiment of the data flow for playback of the IC management platform of FIG. 2.

FIG. 7 is an exemplary top-level block diagram illustrating an embodiment of a scene that is loaded into memory for the playback of FIG. 6.

FIG. 8 is an exemplary top-level block diagram illustrating an embodiment of the branching state diagram of the IC management system of FIG. 1.

FIG. 9 is an exemplary top-level block diagram illustrating an embodiment of the data flow using the branching state diagram of FIG. 8.

FIG. 10A is an exemplary screenshot illustrating an embodiment of a user interface for receiving commands that can be used with the IC management system of FIG. 1.

FIG. 10B is an exemplary screenshot illustrating another embodiment of a user interface for receiving commands that can be used with the IC management system of FIG. 1.

FIG. 11 is an exemplary screenshot illustrating an embodiment of a user interacting with the IC management system of FIG. 1.

FIG. 12 is an exemplary screenshot illustrating an embodiment of the virtual environment being reviewed by the user of FIG. 11.

FIG. 13 is an exemplary screenshot illustrating another embodiment of the virtual environment of FIG. 12 being reviewed by a plurality of reviewers.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION OF THE PREFERRED EMBODIMENTS

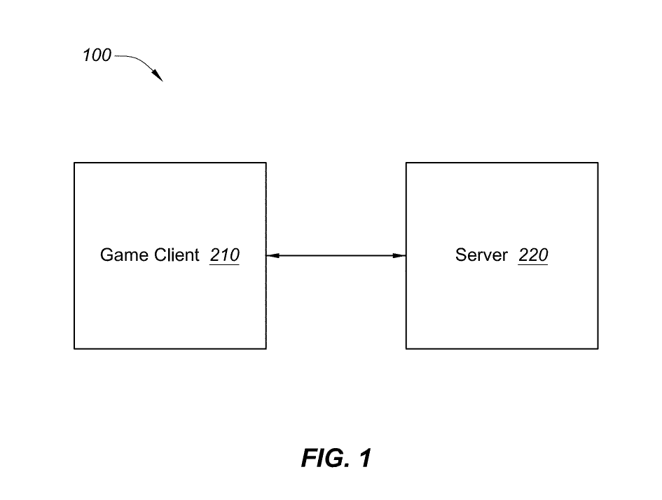

Since currently-available media review systems are incapable of replicating a multi-review environment within an IC system, an IC playback and review system and method that allows reviewers to experience an IC work together in a multi-user, fully synchronized environment can prove desirable and provide a basis for a wide range of media review applications, such as synchronized and distributed playback control, laser pointers, voice communication, and replicated virtually-drawn brush strokes. This result can be achieved, according to one embodiment disclosed herein, by an IC management system 100 as illustrated in FIG. 1.

Turning to FIG. 1, the IC management system 100 includes at least one game client 210 in communication with a server 220. In some embodiments, the game client 210 represents an IC device that includes tracking and motion controllers with at least six-degrees of freedom. The game client 210 can also include other input/output hardware, such as a headset. In a preferred embodiment, the game client 210 includes an Oculus Rift with Touch controllers. However, the game client 210 can include any IC systems, such as a Magic Leap One, an HTC Vive, an HTC Vive Pro, an HTC Vive Focus, an Apple ARKit-enabled device, an Android ARCore-enabled device, a Sony PlayStation VR, a Samsung Gear VR, a Daydream Vue, a Lenovo Mirage, an Oculus Santa Cruz, an Oculus Go, and the like.

As used herein, spatial and immersive computing (IC) refers to virtual reality (VR), augmented reality (AR), mixed reality (MR), extended reality (XR), and so on.

The game client 210 and the server 220 each include a communication system for electronic multimedia data exchange over a wired and/or wireless network. Suitable wireless communication networks can include any category of conventional wireless communications, for example, radio, Wireless Fidelity (Wi-Fi), cellular, satellite, and broadcasting. Exemplary suitable wireless communication technologies include, but are not limited to, Global System for Mobile Communications (GSM), General Packet Radio Service (GPRS), Code Division Multiple Access (CDMA), Wideband CDMA (W-CDMA), CDMA2000, IMT Single Carrier, Enhanced Data Rates for GSM Evolution (EDGE), Long-Term Evolution (LTE), LTE Advanced, Time-Division LTE (TD-LTE), High Performance Radio Local Area Network (HiperLAN), High Performance Radio Wide Area Network (HiperWAN), High Performance Radio Metropolitan Area Network (HiperMAN), Local Multipoint Distribution Service (LMDS), Worldwide Interoperability for Microwave Access (WiMAX), ZigBee, Bluetooth, Flash Orthogonal Frequency-Division Multiplexing (Flash-OFDM), High Capacity Spatial Division Multiple Access (HC-SDMA), iBurst, Universal Mobile Telecommunications System (UMTS), UMTS Time-Division Duplexing (UMTS-TDD), Evolved High Speed Packet Access (HSPA+), Time Division Synchronous Code Division Multiple Access (TD-SCDMA), Evolution-Data Optimized (EV-DO), Digital Enhanced Cordless Telecommunications (DECT) and others.

In some embodiments, the wireless communications between the subsystems of the IC management system 100 can be encrypted, as may be advantageous for secure applications. Suitable encryption methods include, but are not limited to, internet key exchange, Internet Protocol Security (IPsec), Kerberos, point-to-point protocol, transport layer security, SSID hiding, MAC ID filtering, Static IP addressing, 802.11 security, Wired Equivalent Privacy (WEP), Wi-Fi Protected Access (WPA), WPA2, Temporal Key Integrity Protocol (TKIP), Extensible Authentication Protocol (EAP), Lightweight Extensible Authentication Protocol (LEAP), Protected Extensible Authentication Protocol (PEAP), and the like. Encryption methods specifically designed for mobile platform management systems may also be suitable.

Thus, existing wireless technologies for use by current telecommunications endpoints can be readily adapted for use by the game client 210 systems and the server 220. For example, by outfitting each game client 210 with a wireless card like those used for mobile phones, or other suitable wireless communications hardware, additional game clients can easily be integrated into existing networks. Alternatively, and/or additionally, proprietary communications hardware can be used as needed.

Although shown and described as distinct hardware, those of ordinary skill in the art would also understand that the game client 210 and server 220 can reside on the same platform.

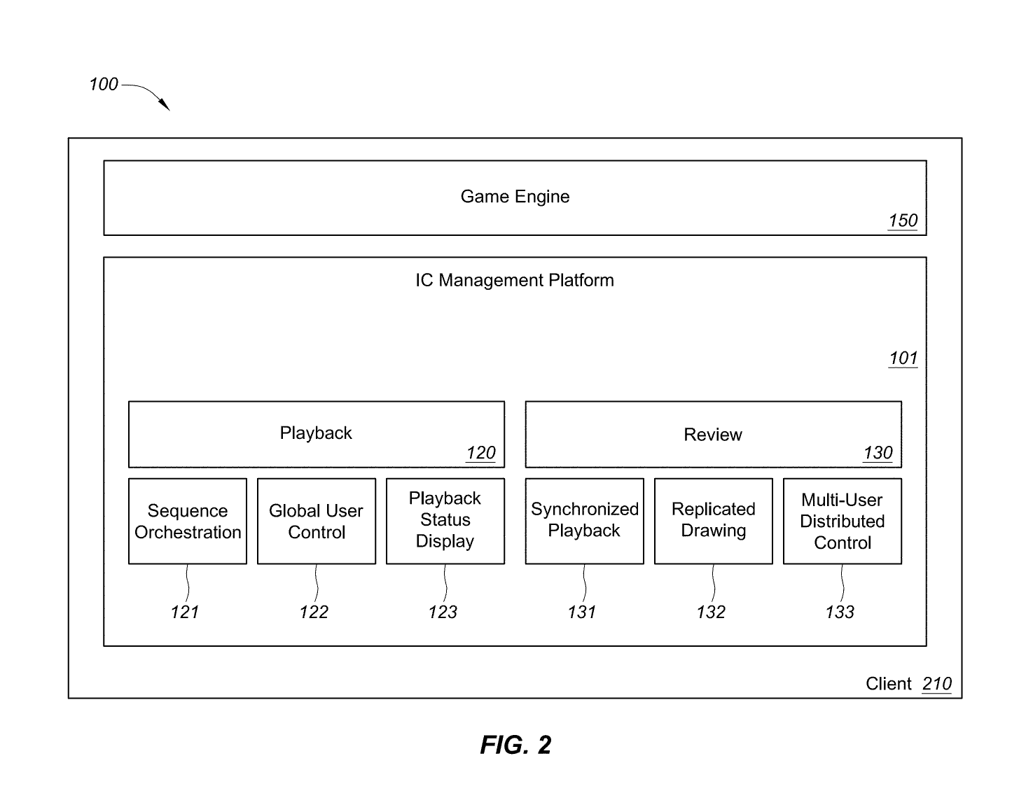

Turning now to FIG. 2, the game client 210 includes an IC management platform 101 that cooperates with one or more game engines 150. The game engines 150 create real-time narrative IC experiences. The game engines 150 provide abstract subsystems such as graphics, platform-specific application program interfaces (APIs), control input/output (I/O), networking, sound, cinematics, and more. An IC experience is built using editors and tooling built on top of these game engines 150. There are typically facilities for creating “plugins”, which include custom code that is run by the engine. By way of example, the game engines 150 can include an Unreal Engine—developed by Epic Games, Unity—developed by Unity Technologies, Frostbite Engine—developed by EA DICE and Frostbite Labs, Cryengine—developed by Crytek, and the like. Advantageously, the IC management platform 101 sits between (e.g., as a plug-in) a selected game engine 150 and the IC experience to enable playback and review tasks in an IC native way to provide the necessary tools to review narrative IC content in a way that is appropriate for the medium.

The game engines 150 provide high level tools for implementing interfaces such as described herein. For example, with the Unreal Engine, a virtual user interface can be created with a Slate user interface framework and UMG user interface designer system. Using hand controllers and a headset, commands are handled using device-agnostic interfaces provided by the specific game engine 150. For example, the IC management system 100 can easily extend to different game clients 210, such as an HTC Vive, an HTC Vive Pro, an HTC Vive Focus, a Sony PlayStation VR, a Samsung Gear VR, a Daydream Vue, a Magic Leap One, a Lenovo Mirage, an Oculus Santa Cruz, an Oculus Go, an Oculus Rift, and the like.

The IC management system 100 can create actionable media, such as networked strokes that can be exported for use in third-party content creation tools, allowing for seamless real world follow-through on notes taken in the virtual word.

Advantageously, the IC management system 100 eliminates conventional “over the shoulder” note delivery from a reviewer in the headset, where all of the other reviewers are outside of the virtual world watching a flat screen with limited context. The IC management system 100 enables all reviewers to be in the IC experience together, whether or not they are physically with the primary reviewer. The primary reviewers can give notes and comments while controlling the playback of a media file (e.g., movie, experience, game, and so on), while the reviewers use networked tools (e.g., such as a virtual drawing) to convey ideas for improving a shot. Even though the participants may be in different physical locations, it will feel to them as if they are all in the same place, on even ground in a way that is not possible in non-IC mediums.

In some embodiments, each reviewer wears a headset and uses a pair of motion controllers to navigate the experience. The IC management system 100 can be cross-platform, and controls can be set up using a palette of buttons and options so users can review the experience in any headset which supports motion controllers. A set of review playback controls are supplied (e.g., fast forward, rewind, and frame skip). Playback commands from one user are synchronized across all sessions, meaning all reviewers are guaranteed to be watching the experience at the same time stamp. In addition, the IC management system 100 includes a variety of review tools (e.g., drawing 3D strokes to be exported and used in non-immersive computing content creation tools, laser pointers, and networked voice communication).

In a preferred embodiment, entering and exiting a networked review session can be a one-click process in the default development environment, ensuring that execution of a review is a lightweight process that can be utilized just as naturally as a traditional review.

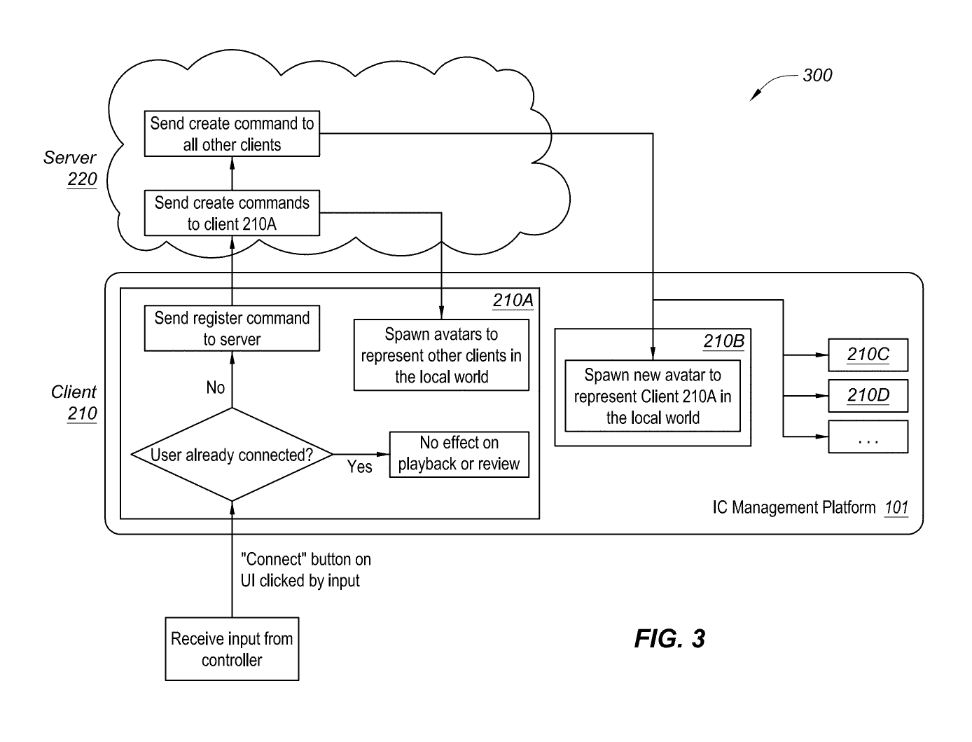

Developers and/or users can enter and exit a networked review session in any manner described herein, such as an exemplary process 3000 of entering a review shown in FIG. 3. Turning to FIG. 3, a game client 210B is shown in further detail. But it should be understand that the features shown in game client 210B can also be used to illustrate the functionality of game clients 210B, 210C, 210D, and any other game clients in the review session. A single input method ensures that execution of a review—from creating or joining a session to shutting it down—is a lightweight process that can be used just as naturally as a traditional review. The process 3000 begins when a user, such as via a game client 210A, “connects” to a session.

If the user is already in session, nothing needs to be done. If the user of the game client 210A is not connected, a registration command is communicated to the server 220. Create commands are then send to the game client 210A to spawn avatars to represent the other game clients 210 that are already in the session/local world. The server 220 broadcasts the same command to all other clients 210 in the session.

In some embodiments, messaging (e.g., for broadcast messages and commands) between network clients/servers include a networking layer—such as described herein—on top of a user datagram protocol (UDP). Messages are passed between client and server using “commands.” By way of example, commands can include register, create, update, world update, destroy, and so on.

Register—register the game client 210 with the server 220 in a particular session.

Create—register a new game client 210 with every logged in game client 210.

Update—update user state properties such as position, laser pointer visibility, or action taken during a branching timeline.

World_Update—update world state properties such as current playback state.

Destroy—de-register the game client 210 with the server 220.

In a preferred embodiment and as shown in FIG. 3, the network architecture is client-authoritative, which means the server 220 broadcasts received state updates to all available game clients 210 with minimal validation (e.g., to avoid conflicts) or sanitation and no world-specific logic exists on the server 220. The server 220 maintains a collection of active review sessions and broadcast commands sent to a session by a game client 210 to all other game clients 210 in that session. Preferably, message processing is executed on the game client 210. This allows logic creation and extension on the client side without need for server updates.

To avoid conflicts between multiple reviewer commands, the IC management system 100 can be networked using finite state machines to control both user actions and a world state. In some embodiments, user actions (associated with a game client 210, for example) can be modeled as user states in a finite state machine. A selected user state includes properties necessary to be shared with other clients in the same review session. For example, the user state can identify the position and rotation of the user's headset and controllers, the color and size of the user's brush, and whether the user is drawing or not, and more. Each user state can be extended to include more properties as desired by the developer. When a property of the user state is changed, the associated game client 210 sends a User Update command to the server 220, which broadcasts that command to all other game clients 210 in the same session as the user. The User Update command is evaluated by the other game clients 210 to update the representation of the specific user in the other clients' virtual worlds.

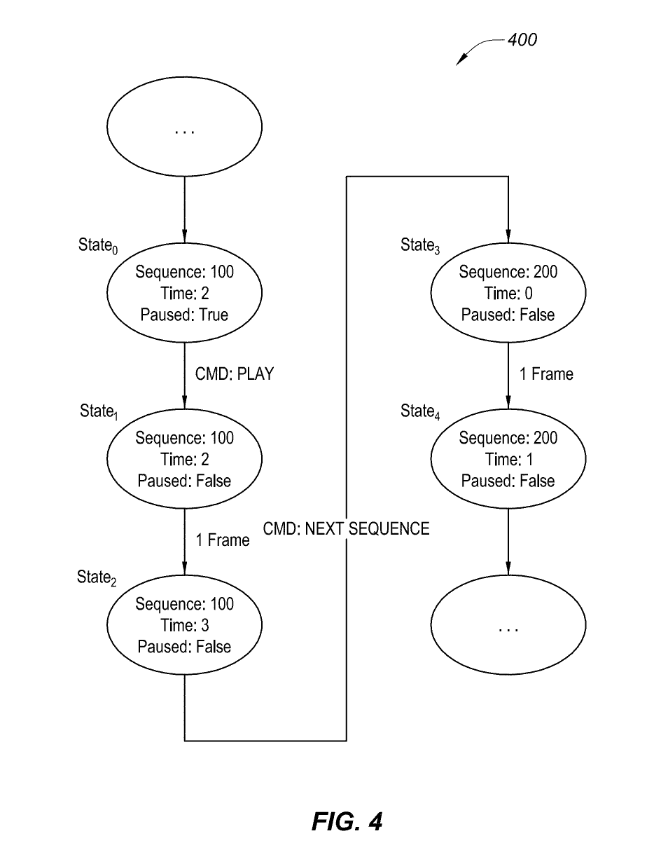

In some embodiments, a world state, such as an exemplary world state 400 shown in FIG. 4, controls the state of scene playback, and implements a Lamport Clock to prevent distributed state collisions. When a user changes the world state, such as changing playback from “paused” to “playing”, a clock counter is incremented and sent along with the state change.

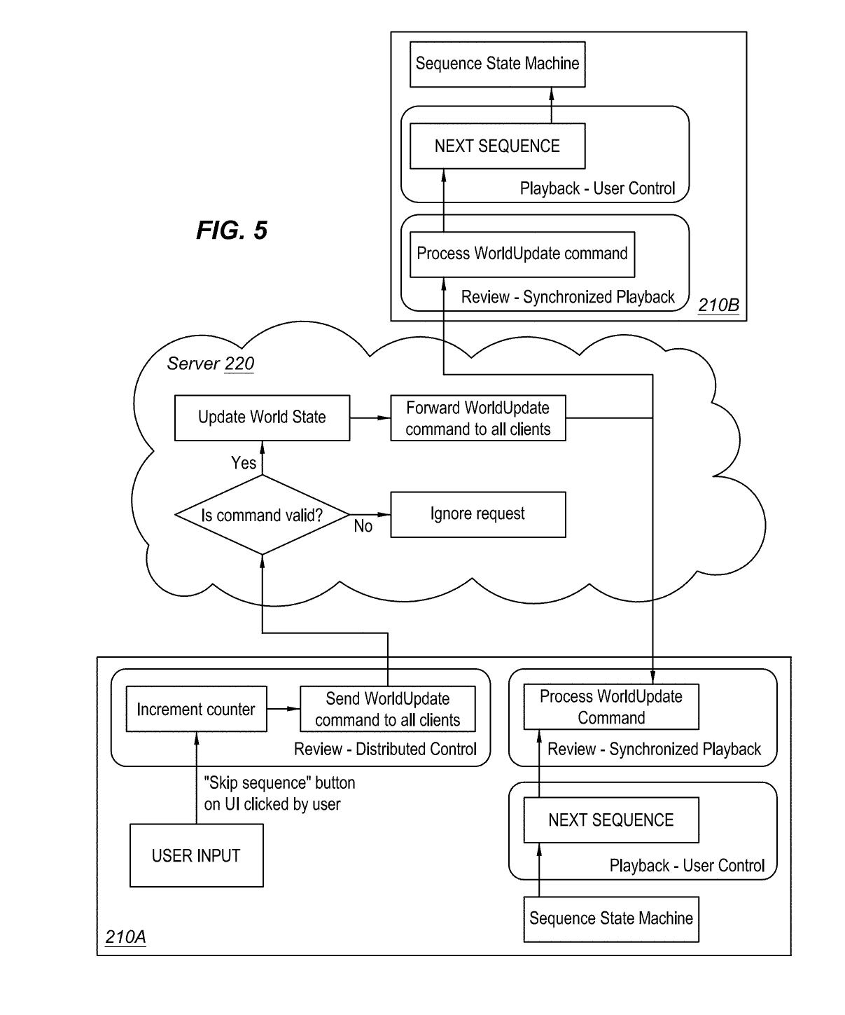

The IC management system 100 can resolve conflicts in any manner described herein, such as an exemplary conflict resolution process 5000 shown in FIG. 5. Turning to FIG. 5, the process 5000 illustrates the data flow for at least two clients attempting to execute the same command. As shown, the game client 210A executes a “next sequence” command at the same time as the game client 210B.

When two actions are received in a predetermined time frame, the server 220 can determine if the actions will conflict and only execute the earlier action while denying the others. In some embodiments, the predetermined time can be defined by the length of time required for a message to be transmitted from a game client 210, processed by the server 220, and broadcast to all clients (e.g., typically less than a millisecond, but dependent on client/server network connection). The server 220 thereby prevents conflict situations, such as “skip forward 5 seconds” being repeated, causing playback to skip forward 10 seconds instead.

Each session/game client 210 maintains a world state, which includes properties describing the current timestamp, playback state, and more, such as shown in FIG. 4. When the server 220 receives a “World_Update” command, the server 220 broadcasts the valid World_Update command to all clients 210 for evaluation.

When the game client 210A wants to execute a playback control, such as the “Next Sequence” control shown in FIG. 5, the game client 210A sends a World_Update command to the server 220, which then broadcasts that command to all clients (if valid), including the game client 201A. All clients will therefore execute the “Next Sequence” control at the same time (or a minor deviation dependent on each client's network connection strength that is negligible), and playback is synchronized across all clients.

As shown in FIG. 5, the execution of the “Next Sequence” command for each game client 201 is processed through a sequence state machine (such as the world state shown in FIG. 4). As shown in FIG. 4 for exemplary purposes only, the units of time can represent frames, the experience is running at 90 frames per second (FPS) (i.e., 90 loops of game logic a second), and each state corresponds to a unique animation frame and playback state. Evaluating a “Play” command causes a transition from State₀ to State₁, where a “Paused” property for each state is now false instead of true. When a frame goes by without any playback controls being received, the state moves forward in time. When a “Next sequence” command is evaluated, a transition from a current state moves to a state where the “Sequence” value is the next sequence and the “Frame” value is 0. When a game client 210 changes the “paused” property from true to false, the clock counter is incremented that is included in the command message body to the server 220.

Although FIG. 4 shows a fairly linear flow from one state to another for illustration purposes only, each state can have several paths to other states that are not shown, and those paths can be taken by executing various playback controls.

The process 5000 is shown and described as resolving conflicts between two game clients 210A and 210B; however, those of ordinary skill in the art will appreciate that the process 5000 can be extended to multiple conflicts between more than two game clients 210. Additionally and/or alternatively, conflict resolution can also include maintaining a selected user's local experience timestamp (e.g., current scene and frame) in a World_Update command to be compared to the other timestamps of other World_Update commands received from other game clients 210. If the timestamps are within a predetermined time of one another (or identical), a selected World_Update command can be used (e.g., first command received with the earliest timestamp.

Returning to FIG. 2, the IC management platform 101 can provide playback controls 120. As described with reference to FIGS. 4 and 5, the playback controls 120 allow multiple users to control sequences in a production by submitting commands to alter the playback world state. The playback world state includes a current sequence number, a current sequence time, whether a sequence is paused, and so on.

For example, the playback controls 120 enable sequence orchestration 121. Designers are able to take high level objects representing sequences in a studio production, and create timelines that fit the experience and needs of production as the production shifts. In a preferred embodiment, the IC management system 100 splits the production into two overlapping constructs to accommodate the dynamic nature of an interactive production in a game engine 150: scenes 201 and sequences 202.

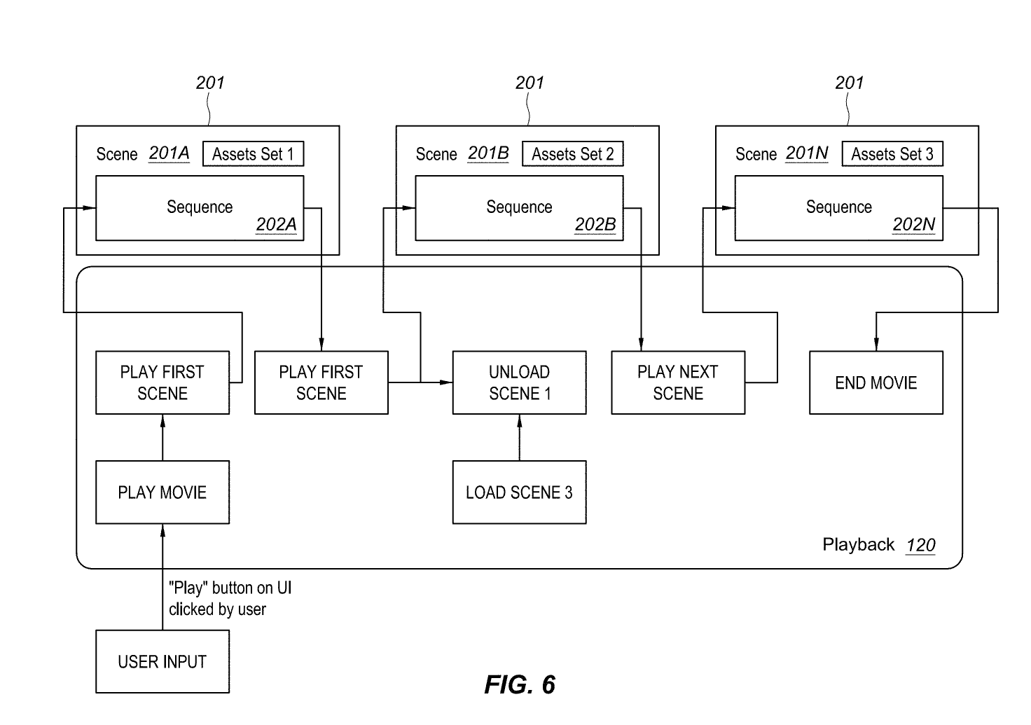

With reference to FIG. 6, an exemplary playback of a production is shown using the IC management system 100. As shown, a selected scene 201 represent a set of assets, much like a set in a theater. Assets can include objects of a particular game engine 150 and/or objects imported from third party applications, such as 3D models, lights, textures, and audio files. By way of example, a scene can include character models and animation rigs, static models of the environment (e.g., houses and furniture), textures for all models, special effects, state machine objects, background music, and audio assets for character dialog. A timeline object in a scene references the assets in the same scene and assigns particular animations to the scene. For example, with the Unreal game engine, scenes are formalized as levels. All sequences 202 use only the assets included in the scene 201 in order to display any images that are shown to a reviewer/user (i.e., rendered to the headset) in the duration of the sequence. Each scene can be further split into one or more sub-scenes. For example, in order to maintain a collaborative workflow, a selected scene 201 can be split up into an animation sub-scene and a visual effects sub-scene.

As described above, a scene's assets are loaded into memory of a game client 210 (or anywhere accessible by the game engine 150) for the game engine 150 to evaluate selected frames. Loading/unloading a scene's assets is analogous to switching sets in a theater play. When a parent scene's assets are loaded/unloaded, the IC management system 100 also loads/unloads the assets of any sub-scenes comprising the parent scene. In some embodiments, the game engine 150 executes the asynchronous movement of scene data in and out of memory. Advantageously, asynchronous loading/unloading guarantees scene transitions that avoid variable waiting times. By eliminating variable scene transition time, the world state of all participants in a review session will remain synchronized, even across multiple scenes.

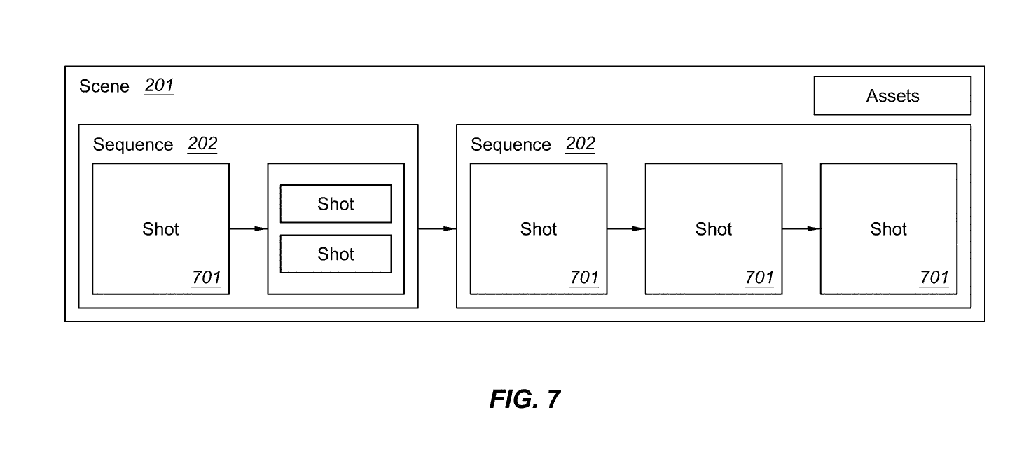

In a preferred embodiment, two sequential scenes are loaded into memory (not shown) of a game client 210 at a selected state in the finite state machine, and a second scene can be immediately started without delay following the ending of a first scene. For example, with reference to FIG. 7, scene 201A and scene 202B can be loaded into memory asynchronously. As the playback of scene 201A completes, the playback of scene 202B can begin immediately while the IC management system 100 can asynchronously unload scene 201A from memory and load scene 201N. This advantageously eliminates the need for loading screens and enables seamless playback for an immersive review/playback experience.

In game engines, a graphic interface can be provided that represents animated data and how it is played back to the user. For example, with the Unreal Engine, sequence objects represent the timelines within each scene, and describe how assets should play and interact with other assets. With reference to FIG. 7, an exemplary scene 201 can include one or more sequences 202. Developers can interface with the graphic interface to insert and order animation clips, also shown as shots 701 in FIG. 7. Shots 701 can be imported into the game engine's cinematic editor with additional properties (e.g., labels). For example, shots 701 can be imported with labels that determine any branching logic discussed herein. Where a selected shot 701 is labeled “A”, the selected shot can be played if an event of type A occurs and a second shot 701 labeled “B” can be played if an event of the type B occurs.

In a preferred embodiment, playback uses ordered lists and maps to determine when a sequence has ended, and moves the playmark to the next sequence for playback. For example, a list of scene numbers can be maintained in a data structure that is ordered by how the scenes are sequentially played. The IC management system 100 can also map scene numbers to a list of sequences, also ordered by the way the scenes are sequentially played. When the last sequence of the ordered list has finished playing, the IC management system 100 can therefore determine that a scene has completed playing and what should be played next (e.g., the first sequence of the next scene). While an IC experience is playing, the IC management system 100 periodically queries the cinematic object of the game engine 150 to determine if the current sequence has ended. If so, the IC management system 100 moves the playmark to the next sequence 202 for playback. Once all the sequences have finished in a scene, the IC management system 100 unloads one scene and loads the next as previously described. Playback includes “hooks” into the start and end of each sequence so events or function calls can take place during the start and end of each sequence. For example, a hook at the beginning of a sequence can be used to move a player of the experience to a virtual position different from where they ended the previous sequence. Additionally and/or alternatively, the hook can be used to trigger a sound cue so that collaborative reviewers are notified when a new sequence has started. This is important for designers and developers to have complete control over what defines the end of a sequence and how that fits into the larger narrative structure.

In some embodiments, a shot can represent a single animation asset, such as a continuous range of animation, much shorter than the length of its parent sequence. A shot therefore includes information that is shared between the game engine 150 and external applications (not shown). For example, timing information can be exchanged during a production, where the lengths and start times of a shot are adjusted for updated animation or timing. The IC management system 100 uses its data structure (e.g., ordered lists and maps discussed above) of scenes and sequences and also its data of shots and properties noted above (e.g., labels) to provide users with the exact name of the shot and frame within the shot being played. By maintaining which shot and frame within that shot is currently being played in the game engine 150, creators and reviewers are able to review their work in the immersive experience, receive feedback on a specific frame or range of frames, and quickly find that same frame in the external content, bringing their workflow closer to that used in traditional content creation reviews.

At certain times in a sequence, it is desired to have the experience and/or characters' actions change in reaction to some action the user performs. For example, at a time B, a character is to turn and look at the user if the user moved since time A, where A precedes B in time. In yet another example, the character can also move in response to a user nodding their head. Specifically, at such a “branch point” in time, the IC management system 100 determines the next shot to play depending on which event Eₓ out of a set of possible events occurred prior to the branch point. For example, states in a branching timeline can be used to monitor and track user input for agreeing with a character (e.g., via head nodding) such that the story can be later branched depending on whether the user agreed with the character at the branch point.

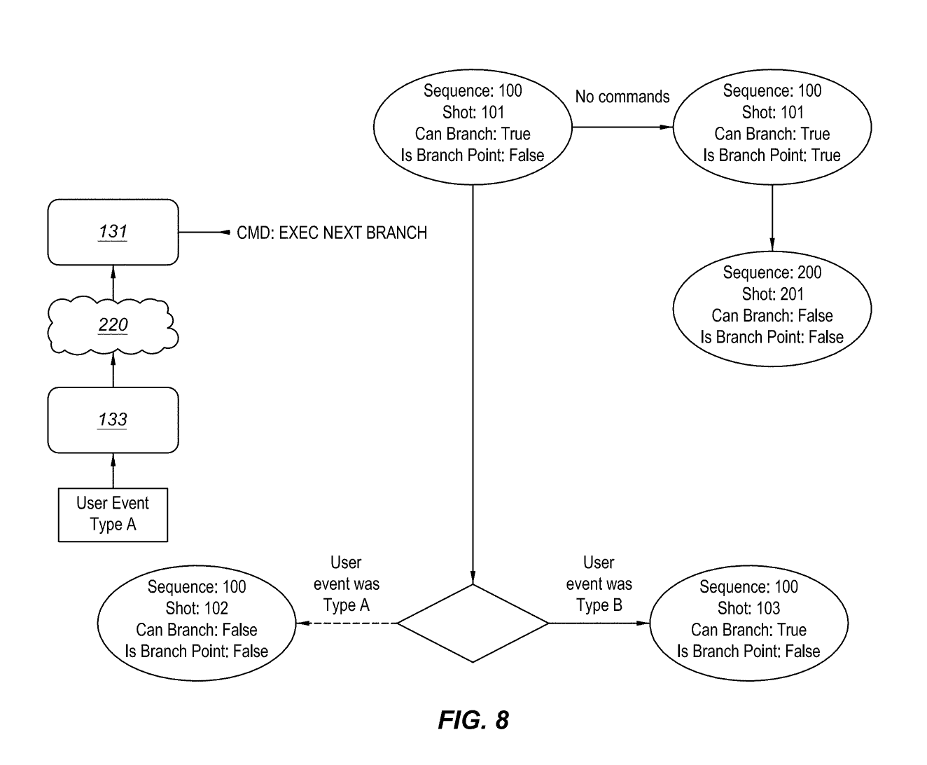

Sequences with branching timelines can be used seamlessly alongside sequences with strictly linear timelines; both are controlled with the same set of playback commands. In some embodiments, branching timelines can include a finite state machine, such as shown in FIG. 8.

The branch point state machine shown in FIG. 8 is similar to the world state machine shown in FIG. 4 and additionally includes properties indicating whether the state is a branch point and/or can branch. When an event Ex (e.g., head nodding) causes the “Execute Next Branch” playback control to be called, if the “can branch” property is true, the world state can take the path to the next branch and the next state is determined by the type of event E. If no “Execute Next Branch” control is received, the world state follows normal sequence orchestration described herein.

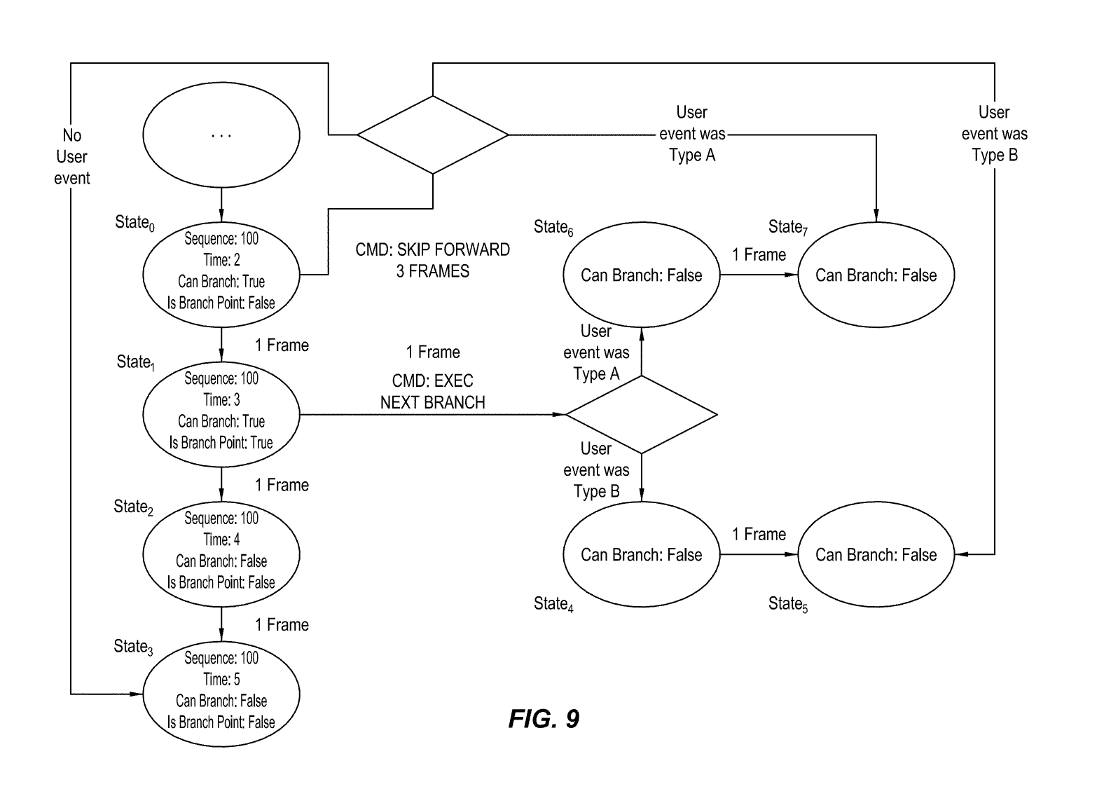

The branching state machine of FIG. 8 advantageously provides users with precise playback control over branching sequences. For example, turning to FIG. 9, at State₀ a first user triggers the “Skip Forward 3 Frames” control. While the IC management system 100 usually jumps to State₃ (e.g., representing the default track that plays when no user events occur), by comparing the properties in State₀ and State₃ that are different, the IC management system 100 determines that a branch point would be skipped and selects the correct next state depending on the user event. For example, consider an event of type A being defined as a user moving position. If the user has moved position at State₀, but the branch point (i.e., the character's reaction to the user move) event does not occur until State₁, the “Skip Forward 3 Frames” command can be triggered at State₀ to move the corresponding number of states (i.e., move from State₀ to State₇ because the user has actually moved instead of State₀ to State₃ in FIG. 9). The user can even specify in the user interface which user events should be assumed as having been taken, so that if, for example, the user executes a “Skip Forward 5 minutes” control and multiple branch steps are skipped, playback resumes at exactly the world state the user wants. When skipping backwards or rewinding to before a branch point occurs, the state machine steps back to the state the correct number of frames back, since branching only occurs in the forward direction. User events are shared in the body of WorldUpdate commands, so user events are also synchronized across multiple users in a review session. This allows users to review different shots and transitions without having to restart the movie or manually perform user events, and to have both precise playback controls and decision tree controls.

With reference again to FIG. 2, the IC management platform 101 also provides global user controls 122. The user has complete control over the current playmark at scene, sequence, shot, and frame granularity, allowing the user to quickly access any point in the narrative within a few motion controller clicks. User control parameters are kept in sync on every frame of playback and are used in review sessions as network inputs to maintain synchronization across clients. For example, pressing the “skip forward 5 seconds” button causes the IC management platform 101 skip forward a predetermined number of seconds. The IC management platform 101 locates the currently playing sequence and the cinematic object that corresponds to that sequence, and calls the function to set the playback position of the object to the desired time (e.g., current time+5 seconds).

Additionally and/or alternatively, the IC management platform 101 also provides a playback status display 123. During playback, the user has a full display of information, both as a heads up display (HUD) and a less intrusive palette on the right motion controller. In some embodiments, this includes the current playback timestamp, current scene, sequence, shot and frame markers, and playback status (playing/paused/rewinding, and play-rate in those states). The global user controls 122 with the display not only allow the user to have fine grained control over the global playback status but also keep track of how the IC review of the item, such as music or frames of animation, relates to work on the item in external applications. The IC management platform 101 can then identify the exact shot and frame within that shot currently being played to advantageously allow the users to review their work in the IC experience, receive feedback on a specific frame or range of frames, and quickly locate that same frame in an external file, and generally bring their workflow closer to that used in traditional content creation reviews.

As also shown in FIG. 2, the IC management platform 101 can provide review controls 130. The review controls 130 work with the playback controls 120 and implements playback synchronization between network clients, replicated note taking mediums (e.g., laser pointing and drawing), and seamless distributed multi-user control with conflict resolution.

Additionally and/or alternatively, a user interface (UI) can be provided to implement the controls described herein. For example, the user interface for controlling the IC management system 100 can be designed as a palette, with the left motion controller acting as the menu, and the right motion controller as a cursor. The right motion controller is pointed at one of the buttons on the left palette, and the trigger is pressed in order to select the option. The UI is immediately updated on the palette to reflect currently available buttons and options, and the currently available options are culled based on the current mode of playback: whether or not network review is enabled, which level in the game engine is currently loaded, etc.

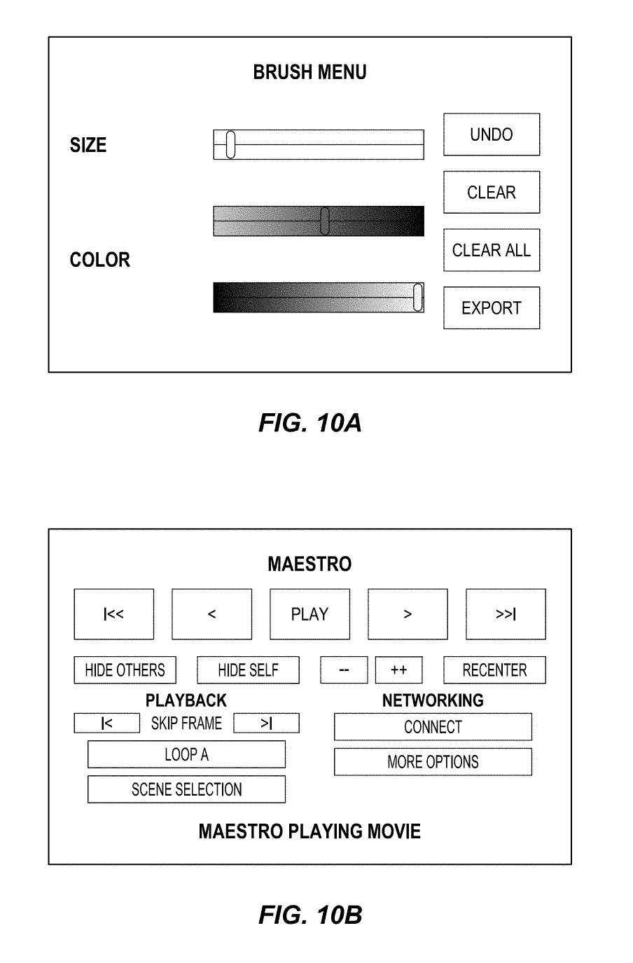

Using a palette design enables easy transitions between IC platforms—such as between the HTC Vive and Oculus Rift—by creating a usable design that is independent of the current platform's motion controller layout. Such as shown in the screenshot of FIG. 10B, the left controller also includes a status display which shows current playback information, and the grip button can be used to switch between different menus, including the playback and brush menus shown in FIGS. 10A-B, respectively.

As shown in FIG. 10B, a variety of user controls are shown.

Connect: Allows users to connect and disconnect from the networked review

Play/Pause/Rewind: Standard playback controls for manipulating the progression of the experience

Cue/chapter jumping: Allows for quickly navigating to different parts of the experience

Playback speed adjustment: Play animated content back faster or slower

Synchronized, distributed network playback: All people participating in the virtual review go through the experience on the same timeline at the same pace

Network replicated drawing: Users can draw strokes in 3D, and all other users can see them

Network drawing FBX export: Drawn strokes can be exported to a common file format for use in external applications

Network replicated pointing: Each user has a laser pointer then can turn on and off to assist with communicating in the IC environment

User-defined network username: Usernames are displayed above each review participant

Network replicated user avatar: Modifiable appearance of each user in the virtual world

Hide/unhide user avatar: Functionality to hide and unhide yourself

Hide/unhide other user avatars: Ability to hide all of the other avatars, which is used when they are distracting and in the way of analyzing the scene

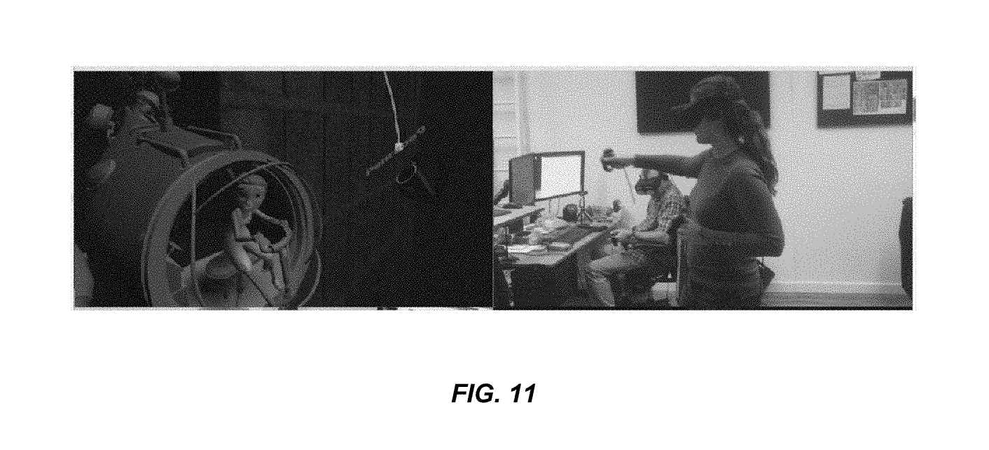

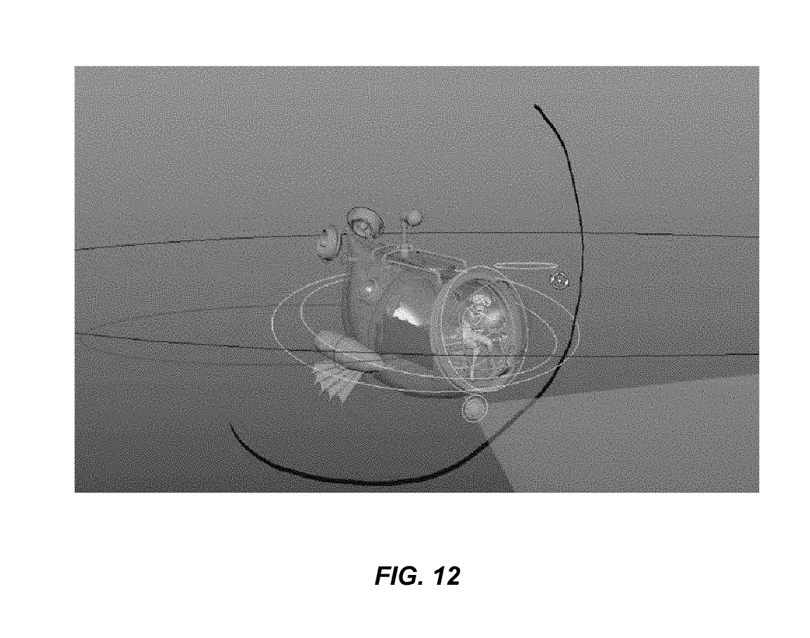

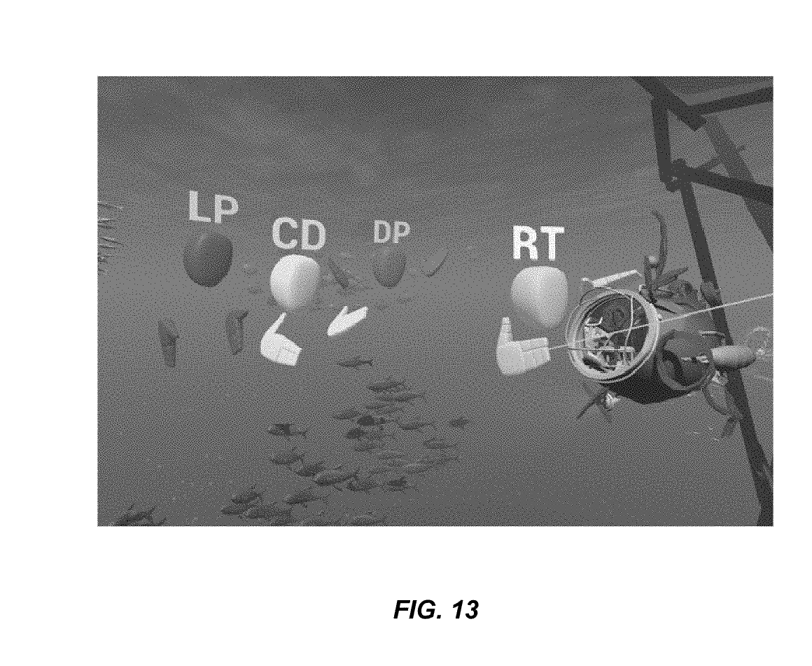

With reference to FIG. 11, an exemplary user is shown interacting with the IC management system 100. The user can be an animator that is drawing a virtual stroke that can be seen on the virtual screen. All other users—independent of their physical location—can view the virtual strokes of the animator. Turning to FIG. 12, the virtual strokes created in FIG. 11 can be imported into an animation platform as shown. This animation platform can be used for guiding animation using conventional editing tools. As shown in FIG. 13, three reviewers can be seen in the virtual environment that are analyzing a common drawing.

The disclosed embodiments are susceptible to various modifications and alternative forms, and specific examples thereof have been shown by way of example in the drawings and are herein described in detail. It should be understood, however, that the disclosed embodiments are not to be limited to the particular forms or methods disclosed, but to the contrary, the disclosed embodiments are to cover all modifications, equivalents, and alternatives.

What is claimed is:

1. An immersive computing management system, comprising:
a server; and
one or more game client devices in communication with the server over a data network, wherein each game client device comprises:
a game engine for providing an immersive computing environment for media playback and review;
an immersive computing platform in operative communication with the game engine to provide playback controls for the playback and review controls for the review for multi-media editing; and
a display device for presenting a user interface to select from the playback controls and the review controls for multi-user review in the immersive computing environment,
wherein a selected immersive computing platform receives a selection of at least one of a playback control and a review control, increments a counter, and sends a world update command to the server, the world update command detailing the selection of the at least one playback control and review control, and
wherein the server receives one or more world update commands from the one or more game client device, determines whether the world update command is valid based on a timestamp of the selection, and broadcasts a valid world update command to the one or more game client devices.

2. The immersive computing management system of claim 1, wherein the immersive computing platform maintains a world state diagram to model user states and a world state for networking the one or more game client devices.

3. The immersive computing management system of claim 2, wherein the world state diagram is a finite state machine.

4. The immersive computing management system of claim 3, wherein the immersive computing platform further maintains a Lamport Clock for preventing distributed state collisions of the finite state machine.

5. The immersive computing system of claim 3, wherein each state of the finite state machine maintains a sequence number, a time value, and a playback tag.

6. The immersive computing management system of claim 1, wherein each game client device shares a common network session with any other game client device present for review in the immersive computing environment.

7. The immersive computing management system of claim 6, wherein each game client device enters the common network session via a one-click process, the one-click process including a world update command being sent to the server.

8. The immersive computing management system of claim 1, wherein the game engine is a real time game engine.

9. The immersive computing management system of claim 1, wherein the display device is at least one of virtual reality headset, a head mounted display, an augmented reality head mounted display, and a mixed reality head mounted display.

10. The immersive computing management system of claim 1, wherein each game client device further comprises an input device for selecting from the playback controls and the review controls.

11. A computer-implemented method for immersive computing management, comprising:
providing an immersive computing environment for media playback and review via a game engine;
providing playback controls for the media playback and review controls for the media review for multi-media editing via an immersive computing platform of at least one game client device in communication with a server over a data network;
displaying a user interface to select from the playback controls and the review controls for multi-user review in the immersive computing environment
receiving a selection of at least one of a playback control and a review control via the immersive computing platform,
incrementing a counter based on the received selection, and
sending a world update command to the server from the immersive computing platform, the world update command detailing the selection of the at least one playback control and review control, and
receiving one or more world update commands at the server from the game client device,
determining whether the world update command is valid based on a timestamp of the selection, and
broadcasting a valid world update command to the one or more game client devices.

12. The method for immersive computing management of claim 11, further comprising maintaining a world state diagram at the immersive computing platform to model user states and a world state for networking the game client devices.

13. The method for immersive computing management of claim 12, wherein the world state diagram is a finite state machine.

14. The method for immersive computing management of claim 13, wherein said maintaining a world state diagram comprises maintaining a Lamport Clock for preventing distributed state collisions of the finite state machine.

15. The method for immersive computing management of claim 13, wherein said maintaining a world state diagram comprises, for each state of the finite state machine, maintaining a sequence number, a time value, and a playback tag.

16. The method for immersive computing management of claim 11, wherein each game client device shares a common network session with any other game client device present for review in the immersive computing environment.

17. The method for immersive computing management of claim 16, further comprising entering the common network session via a one-click process, the one-click process including a world update command being sent to the server.

18. The method for immersive computing management of claim 11, wherein said providing the immersive computing environment for media playback and review is provided by a real time game engine.

19. The method for immersive computing management of claim 11, wherein said displaying a user interface comprises displayed the user interface to at least one of virtual reality headset, a head mounted display, an augmented reality head mounted display, and a mixed reality head mounted display.

20. The method for immersive computing management of claim 11, further comprising selecting from the playback controls and the review controls via an input device of the game client.
